(19) United States
(12) Patent Application Publication
(10) Pub. No.: US 2025/0368320 A1
(43) Pub. Date: Dec. 4, 2025

(54) AUTOMATIC CONTROL SYSTEM OF AIRCRAFT, EFFECTIVENESS EVALUATION METHOD THEREFOR, AND MEASUREMENT APPARATUS FOR THE AUTOMATIC CONTROL SYSTEM

(71) Applicant: JAPAN AEROSPACE EXPLORATION AGENCY, Tokyo (JP)

(72) Inventors: Hamaki INOKUCHI, Tokyo (JP); Yoshiro HAMADA, Tokyo (JP)

(21) Appl. No.: 19/107,412

(22) PCT Filed: Jul. 18, 2023
(86) PCT No.: PCT/JP2023/026239

§ 371 Date: Feb. 27, 2025

(30) Foreign Application Priority Data
Sep. 2, 2022 (JP) 2022-139629

(51) Int. Cl. B64C 13/20

(52) U.S. Cl. CPC B64C 13/20

(57) ABSTRACT

An automatic control system of an aircraft according to an embodiment of the present invention includes: a measurement unit that measures, as preview information, a difference between a wind speed actually received by an aircraft and a wind speed to be encountered in future, adds information for identifying an estimation error or validity/invalidity of a measured value to measurement information, and outputs the resultant information; a control surface that controls lift, drag, or an attitude of the aircraft, or an apparatus that controls thrust; and a control arithmetic unit that calculates an angle of the control surface or the thrust to reduce an action of the wind speed exerted on an aircraft, on the basis of a wind speed value in a planned flight direction of the aircraft, the wind speed value being measured by the measurement unit.

### TECHNICAL FIELD

The present invention relates to a technology regarding an automatic control system of an aircraft, and more specifically to, a gust alleviation system and method used for reducing the acceleration of an aircraft or a gust load alleviation system and method used for reducing a load applied to an aircraft, for example, when an aircraft enters turbulence.

### BACKGROUND ART

Turbulence is particularly important as a main cause of aircraft accidents, and the technology regarding a Doppler lidar using laser light has been researched and developed as an airborne device that detects turbulence in advance (see, for example, Non-Patent Literature 1). Afterwards, the performance limits of the Doppler lidar have become clear along with the progress of research and development, and thus the inventors of the present invention propose a highly effective use method (see, for example, Non-Patent Literature 2).

To use the Doppler lidar to prevent turbulence-induced accidents of aircrafts, the following methods are employed, such as a method of reporting information of turbulence occurring forward in a flight direction to a pilot such that the pilot copes with the turbulence by operating the flight to avoid the turbulence, turning on the seat belt sign, and the like, and a method of transmitting airflow information to an on-board computer and automatically controlling a control surface to thereby reduce the vertical acceleration of the aircraft when the aircraft runs into the turbulence (see, for example, Patent Literature 1).

To control the above-mentioned control surface, a vertical airflow vector generally needs to be obtained. The inventors of the present invention propose, in Patent Literature 2, a technology of geometrically converting observation values of two sets of Doppler lidars (remote airflow measurement apparatus) to obtain a vertical airflow vector.

Further, in Patent Literature 3, the inventors of the present invention propose a remote airflow measurement apparatus, a remote airflow measurement method, and a program that are capable of improving estimation accuracy of a two-dimensional airflow vector including a vertical airflow vector, and further broadening an airflow estimation range.

However, if an airflow vector is used as preview information in the vertical acceleration reduction control to automatically control the control surface, the preview information is requested to have extremely high reliability. If automatic control is performed on the basis of erroneous information, conversely, the vertical acceleration may be expanded. Thus, the inventors of the present invention propose in Patent Literature 4 a technology of adding reliability information to observation signals. Here there has been a problem of how to effectively utilize those observation signals.

Meanwhile, the inventors of the present invention propose in Patent Literature 5 a technology of easily reducing a vertical acceleration of an airplane. However, advantageous effects of this technology are considered to be limitative and are exerted only in the reduction of a vertical acceleration of an airplane.

### CITATION LIST

### Patent Literature

Patent Literature 1: Japanese Patent No. 5771893
Patent Literature 2: Japanese Patent No. 5398001
Patent Literature 3: Japanese Patent No. 6583677
Patent Literature 4: Japanese Patent Application No. 2017-234165
Patent Literature 5: Japanese Patent Application No. 2018-72705

### Non-Patent Literature

Non-Patent Literature 1: H. Inokuchi, H. Tanaka, and T. Ando, “Development of an Onboard Doppler lidar for Flight Safety,” Journal of Aircraft, Vol. 46, No. 4, PP. 1411 -1415, AIAA, July-August 2009.
Non-Patent Literature 2: H. Inokuchi, T. Akiyama, “Performance Evaluation of an Airborne Coherent Doppler Lidar and Investigation of its Practical Application” Transactions of JSASS, Vol. 65, No. 2, PP. 47-55, March 2022.
Non-Patent Literature 3: Hamada, “Discrete-time preview feedforward compensation and application to gust alleviation control”, the 57^{th} Japan Joint Automatic Control Conference, 2014.
Non-Patent Literature 4: Y. Hamada, “New lmi-based conditions for preview feedforward synthesis” Control Engineering Practice, Vol. 90, PP. 19-26, 2019.

### DISCLOSURE OF INVENTION

### Technical Problem

In the case of conventional feedback control to reduce the acceleration of an aircraft, a control surface angle is controlled usually on the basis of an output of an acceleration sensor attached to the aircraft. In this case, a delay is generated due to an inertial force of the aircraft from the first encounter with a gust to the beginning of motion of the aircraft. Further, the motion of the aircraft is measured by the acceleration sensor, a suitable control surface angle is calculated, and then a control surface angle command is transmitted to an actuator of the control surface, which also causes a delay until an aerodynamic force of the control surface is changed. Therefore, there has been a possibility of failing to respond to the initial acceleration or conversely adding vibrations.

For example, if the airflow information is used to automatically control the control surface as described above, inappropriate control of the control surface due to erroneous signals and observation errors is unacceptable for the operational safety of the aircraft. Nevertheless, the conventional technologies have had a possibility of providing inappropriate control due to erroneous signals generated in some rare cases. In other words, the conventional technologies have failed to use reliability information of control input signals, leading to a possibility that the safety is lower than the case where the control is not performed, depending on the conditions. Since the erroneous signals are caused by noise constantly present, it is impossible to consider the erroneous signals as being zero. Further, there has been a disadvantage that the control accuracy is lowered when data with many observation errors is mixed.

For vertical and fore-and-aft airflow estimation of gusts using a Doppler lidar, optical axes of two or more lines of sight are required. For a test Doppler lidar constructed so far, the measurement accuracy of the optical axes along the lines of sight is 0.2 to 0.3 m/s from the results of Monte Carlo simulations and flight tests. When this is converted into vertical airflow vectors, the estimation accuracy is 0.6 to 0.9 m/s when the angle between the optical axes is 20 degrees.

As long as the above accuracy is guaranteed at all times, flight simulation results have shown that the vertical acceleration of the aircraft is appropriately reduced by half. In actual measurement, however, measurement errors may temporarily increase due to noise, or signals may take singular values due to a failure to perform suitable measurement. If those pieces of low-quality measurement information are used as they are to perform control, the aircraft may undergo a larger vertical acceleration than the case where no control is performed.

Additionally, the automatic control of the control surface requires a high sampling rate. When measurement is performed in optical axis directions of two or more lines of sight, respective local flows are measured. If the measurement time is short, the overall flow becomes difficult to estimate due to the influence of fine turbulence.

In view of the circumstances as described above, it is an object of the present invention to provide an automatic control technology capable of reducing the acceleration of an aircraft or reducing the load applied to the aircraft when an aircraft enters turbulence even if preview information has a slight measurement error.

### Solution to Problem

An automatic control system of an aircraft according to an embodiment of the present invention includes: a measurement unit that measures, as preview information, a difference between a wind speed actually received by an aircraft and a wind speed to be encountered in future, adds information for identifying an estimation error or validity/invalidity of a measured value to measurement information, and outputs the resultant information; a control surface that controls lift, drag, or an attitude of the aircraft, or an apparatus that controls thrust; and a control arithmetic unit that calculates an angle of the control surface or the thrust to reduce an action of the wind speed exerted on an aircraft, on the basis of a wind speed value in a planned flight direction of the aircraft, the wind speed value being measured by the measurement unit.

The automatic control system described above can reduce an adverse influence caused by an measurement error of preview information by selectively using only high-quality preview information and performing automatic control of the aircraft.

The measurement unit may be configured to emit electromagnetic waves toward the planned flight direction of the aircraft, receive scattered waves in atmosphere, and measure a remote wind speed in an emission axis direction of the electromagnetic waves on the basis of a Doppler shift amount of the scattered electromagnetic waves with respect to the emitted electromagnetic waves.

The measurement unit may provide two or more lines of sight of emission axes of the electromagnetic waves or performs scanning by the electromagnetic waves to obtain a two-dimensional or three-dimensional vector of the wind speed. This makes it possible to add, as information for determining validity/invalidity, a difference between measured values obtained from the two or more lines of sight of emission axes of electromagnetic waves to measurement information.

The control arithmetic unit may be configured to calculate the wind speed value on the basis of a moving average value of spectrally-integrated reception signals from which a reception signal with invalidity information has been removed. The time range to be spectrally integrated is moved with time, so that measured values with higher data rate can be used as an input for automatic control.

The control arithmetic unit may be configured to perform automatic control of the control surface on the basis of an output of an acceleration sensor that detects an acceleration acting on the aircraft if the estimation error has a set value or more or if preview information with invalid information is received.

The control arithmetic unit may be configured to define a numerical value obtained by dividing the estimation error by a set value to be subtracted from 1, as an authority, and multiplies the control command by a larger value of 0 or the authority.

The control arithmetic unit may be configured to generate the control signal by regarding a larger value of a value obtained by subtracting the estimation error from the measured value or 0 as the wind speed value.

If a measurement error of a certain range bin is larger than an absolute value assumed in advance or if invalid information is added to the measured value, the control arithmetic unit may be configured to calculate the angle of the control surface by using measured values of range bins located before and after the certain range bin.

If a bias-like measurement error that is a constant value is added to the measured value of each range bin, the control arithmetic unit may be configured to use a control gain that cancels out an influence of the bias-like measurement error.

An effectiveness evaluation method for the automatic control system according to an embodiment of the present invention includes: performing a flight test or flight simulation of an aircraft under a predetermined wind speed flow condition including a vertical wind speed; plotting results of the flight test or flight simulation, with a horizontal axis representing an acceleration change amount of the aircraft when automatic control based on a control command is not performed and a vertical axis representing an acceleration change amount of the aircraft when the automatic control is performed; and regarding divergence of plots below a line graph set in advance as a gust alleviation effect provided by the automatic control.

A measurement apparatus according to an embodiment of the present invention is a measurement apparatus for an automatic control system of an aircraft that measures, as preview information, a difference between a wind speed actually received by an aircraft and a wind speed to be encountered in future, the measurement apparatus including a signal processing unit that adds, as information for determining validity/invalidity, a difference between measured values obtained from two or more lines of sight of emission axes of electromagnetic waves to measurement information and outputs the resultant information.

### Advantageous Effects of Invention

According to the present invention, it is possible to reduce an adverse influence due to an measurement error of preview information in automatic control of reducing the acceleration or load on an aircraft when the aircraft enters turbulence.

### BRIEF DESCRIPTION OF DRAWINGS

FIG. 1 is a block diagram showing a configuration of an automatic control system of an aircraft according to an embodiment of the present invention.

FIG. 2 is a conceptual diagram showing a method of measuring a forward airflow to be encountered by an aircraft in the automatic control system.

FIG. 3 is a flowchart showing an operation of a control arithmetic unit in the automatic control system.

FIG. 4 is an explanatory diagram showing a technique of calculating a moving average value that is performed by the control arithmetic unit.

FIG. 5 is an explanatory diagram showing a method of using an estimated measurement error in the automatic control system.

FIG. 6 is an explanatory diagram showing a technique of estimating measured values of range bins from fore-and-aft measurement points and calculating an angle of a control surface in the automatic control system.

FIG. 7 is an explanatory diagram showing a configuration of a control input in the automatic control system.

FIG. 8 is an explanatory diagram showing a technique of performing observations in four lines of sight and reducing variations in a roll angle in the automatic control system.

FIG. 9 is a graph showing the distribution of a vertical wind speed used in a flight simulation for evaluating effectiveness of the automatic control system.

FIG. 10 is a diagram showing measured values and true values of a forward wind speed of the aircraft at a certain time in an example of the flight simulation for evaluating effectiveness of the automatic control system.

FIG. 11 is a diagram showing temporal changes in an elevator control surface angle and a perpendicular acceleration in the example of the flight simulation for evaluating effectiveness of the automatic control system.

FIG. 12 is a diagram of a flight simulation example for showing a technique of evaluating effectiveness of the automatic control system.

FIG. 13 is a diagram for describing a technique of easily calculating reliability information of wind speed measurement.

### MODE(S) FOR CARRYING OUT THE INVENTION

Hereinafter, an embodiment of the present invention will be described with reference to the drawings.

### [Configuration of Gust or Gust Load Alleviation System]

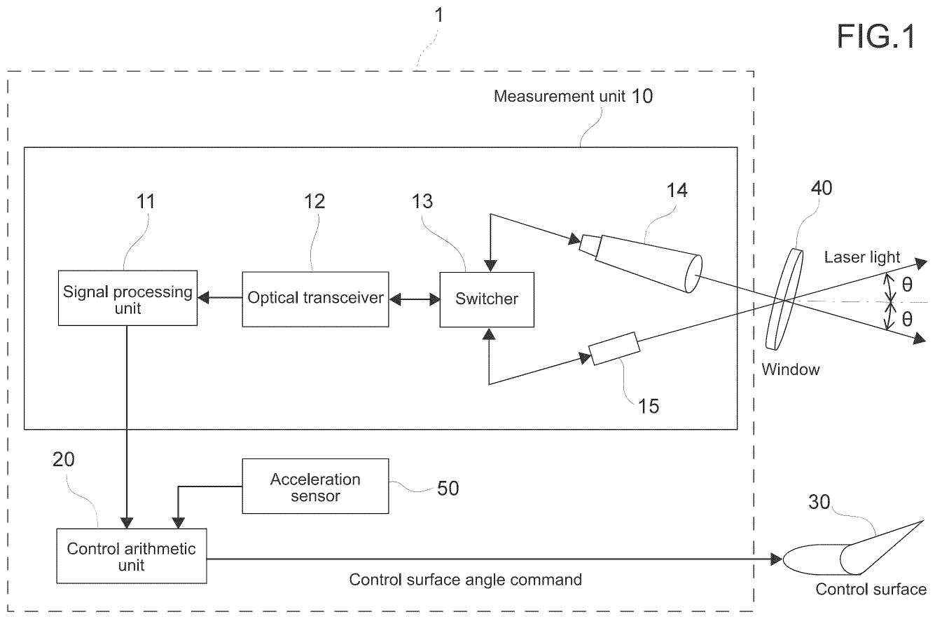

FIG. 1 is a block diagram of a configuration of an automatic control system 1 of an aircraft according to an embodiment of the present invention. In this embodiment, the automatic control system 1 is configured as an airborne optical gust or gust load alleviation system of a Doppler lidar system.

As shown in FIG. 1, the automatic control system 1 of this embodiment includes a measurement unit 10, a control arithmetic unit 20, and a control surface 30.

### (Measurement Unit)

The measurement unit 10 is a device that measures, as preview information, a difference between a wind speed actually received by an aircraft 200 and a wind speed to be encountered in the future, adds information for determining an estimation error or validity/invalidity of the measured value to measurement information, and outputs the resultant information.

In this embodiment, the measurement unit 10 emits laser light in a pulse form in two directions in the atmosphere, receives reflected light thereof, and measures an axial wind speed of each optical axis on the basis of a Doppler shift amount in frequency between the emitted laser light and the reflected light. The measurement unit 10 includes an optical transceiver 12, a switcher 13, a first telescope 15, a second telescope 14, and a signal processing unit 11.

The optical transceiver 12 generates laser light to be emitted and converts received laser light into electric signals. The switcher 13 selects the first telescope 14 and the second telescope 15 sequentially. The first telescope 14 emits and receives laser light through a window 40 to the downward side of an aircraft body axis. The second telescope 15 emits and receives laser light through the window 40 to the upward side of the aircraft body axis. Here, the angle formed by the optical axis of the upward or downward laser light with respect to the aircraft body axis is set to 0.

Here, an example in which the first telescope 14 is a telescope for long distance and the second telescope 15 is a telescope for short distance will be described, but the prevent invention is not limited thereto. The same telescope (e.g., a telescope for short distance or a telescope for long distance) may be employed as the first telescope 14 and the second telescope.

The optical transceiver 12 generates and amplifies laser light of a single wavelength, for example, 1.5 μm, and also receives scattered light thereof and measures a frequency change amount (wavelength change amount) based on the Doppler effect, to thereby measure a wind speed. This is generally called Doppler lidar. LIDAR is an abbreviation for “Light Detection And Ranging”, that is, a technique for remote observation that uses light.

The frequency change amount based on the Doppler effect is obtained by comparing the frequency (wavelength) of reception light (scattered light) received via the first telescope 15 or the second telescope 14 with the frequency (wavelength) of transmission light. Using this principle, the measurement unit 10 measures preview information, which is a difference between a wind speed actually received by the aircraft and a wind speed to be encountered in the future.

In this embodiment, the laser light, which is a transmission signal, is a successive pulse train emitted into the atmosphere. Thus, a reception signal is also a pulse train. Additionally, a signal train of the frequency change amount based on the Doppler effect, that is, a signal train of a difference between the frequency of the reception signal, which is obtained when a reflected signal of the transmission signal is received, and the frequency of the transmission signal is also a pulse train.

The signal processing unit 11 calculates a wind speed and reliability information of wind speed measurement. The reliability information means information for determining an estimation error or validity/invalidity of the measured value that is preview information.

The estimation error refers to an up-down wind speed difference, which is a difference between the wind speed measured using the first telescope 14 (wind speed in optical axis L1) and the wind speed measured using the second telescope 15 (wind speed in optical axis L2). The estimation error is represented in the same units as the measured value, and is represented as an absolute value of a deviation centered on the measured value in the range estimated to include a true value.

For the determination of validity/invalidity of the measured value, if the up-down wind speed difference (difference between the measured value in the optical axis L1 and the measured value in the optical axis L2) is less than a first set value, the measured value is determined to be valid, and if the difference exceeds the first set value, the measured value is determined to be invalid. Note that the reliability information of the wind speed measurement may be calculated, for example, using the technology of Patent Literature 4.

The first set value is set as an absolute value in consideration of the reliability of the entire system on the basis of the difference between the wind speed actually received by the aircraft and the wind speed to be encountered in the future. The first set value can use, for example, not a fixed value such as 1 m/s, but a variable obtained by multiplying the measured value of the up-down wind by a coefficient equal to or smaller than 1.

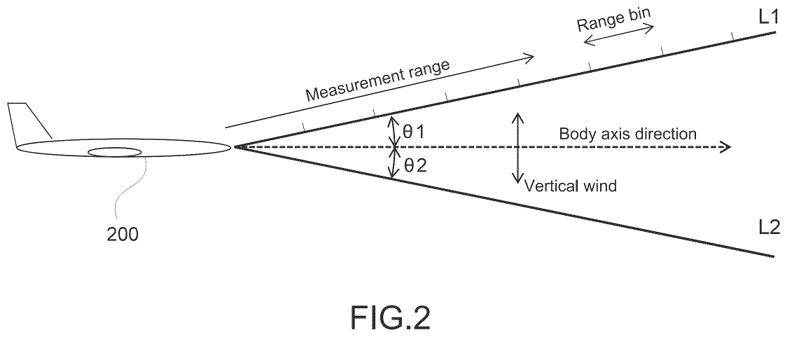

For example, as shown in FIG. 2, the measurement unit 10 emits laser light in the directions (optical axes L1 and L2) at angles θ1 and θ2 formed above and below the aircraft body axis X of the aircraft 200, and receives scattered light thereof as spectral data of the distances of the laser light along the optical axis directions. For example, 20 measured values are obtained for respective range bins, each of which has a distance width (e.g., 25 m) corresponding to sampling intervals, from a measurement range within 500 m. In other words, the measurement unit 10 measures the wind speeds at 20 locations of the respective range bins in each of the optical axes L1 and L2 by emitting laser light in each direction (optical axes L1 and L2). This measured value, wind speed data, is also referred to as a lidar measured value.

Note that the wind speed data may include erroneous measured values, and thus the measurement unit 10 adds independent reliability information to the wind speed data of each range bin. In other words, the reliability information regarding wind speed data (validity/invalidity flag as a determination result of estimation error or validity/invalidity) is added to the wind speed data of each range bin. Since the wind speed data is a wind speed component in the optical axis direction, the wind speed data can be calculated by, for example, obtaining an up-down wind or a wind speed vector using the technology of Patent Literature 3.

### (Control Arithmetic Unit)

The control arithmetic unit 20 calculates an angle or thrust of the control surface 30 that reduces an action of the wind speed exerted on the aircraft 200, on the basis of a wind speed value (wind speed data) in a planned flight direction of the aircraft, which is measured by the measurement unit 10. The calculated angle or thrust of the control surface 30 generates input information (control command) for automatically controlling the control surface 30 or a thrust generator (illustration thereof is omitted).

Additionally, if a predetermined number of pieces of wind speed data to which invalidity flags are added is included (in this embodiment, if invalidity flags are added to the wind speed data of all range bins), the control arithmetic unit 20 performs automatic control of the control surface angle based on the output of an acceleration sensor 50 attached to the aircraft 200 (see FIG. 1), on the basis of the reliability information regarding the wind speed data in the planned flight direction of the aircraft, which is measured by the measurement unit 10.

The acceleration sensor is configured to be capable of detecting, for example, an acceleration/accelerations in a uniaxial or biaxial direction perpendicular to the aircraft body axis. For automatic control of the control surface angle based on the output of the acceleration sensor 50, for example, the feedback control technology of a control surface angle is used such that the acceleration acting on the aircraft 200 has a predetermined value or smaller.

Specifically, the control surface 30 as a controlled object corresponds to flight control surfaces or ailerons for controlling lift, drag, or an attitude of an aircraft, such as elevators, a rudder, flaperons, throttles, spoilers, direct lift control (DLC) flaps, and ailerons. If the aircraft 200 is a propeller aircraft, the pitch angle of the propeller may also be controlled. Note that the controlled object is not limited to the control surface 30 and may include a jet engine that generates thrust of the aircraft 200 or an apparatus such as a propeller propulsion unit.

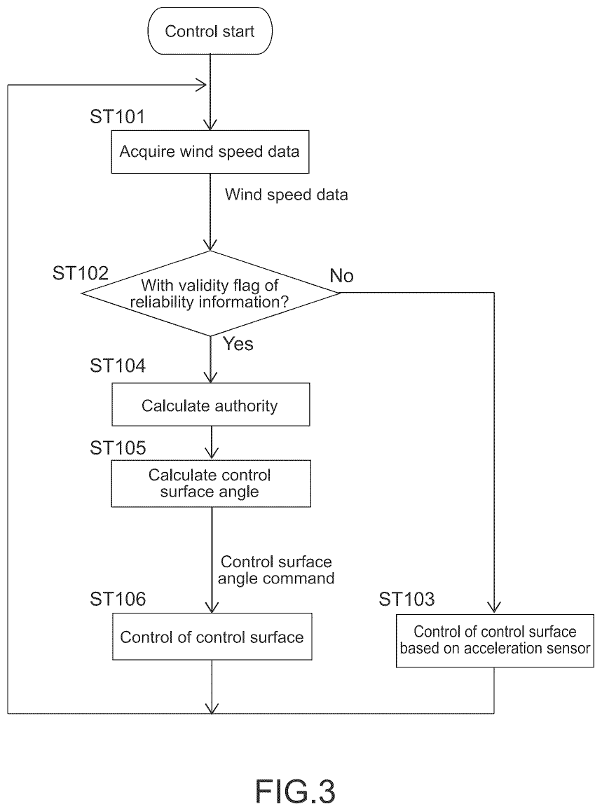

FIG. 3 is a flowchart showing an operation of the control arithmetic unit 20.

The control arithmetic unit 20 acquires the wind speed data from the measurement unit 10 and proceeds with processing according to the reliability information contained in the wind speed data (Step 101). First, if invalidity flags are added to all range bins as reliability information (No in Step 102), the control according to the present invention is not performed while such a state is continued, and only feedback control based on the output of the acceleration sensor 50 described above is used (Step 103).

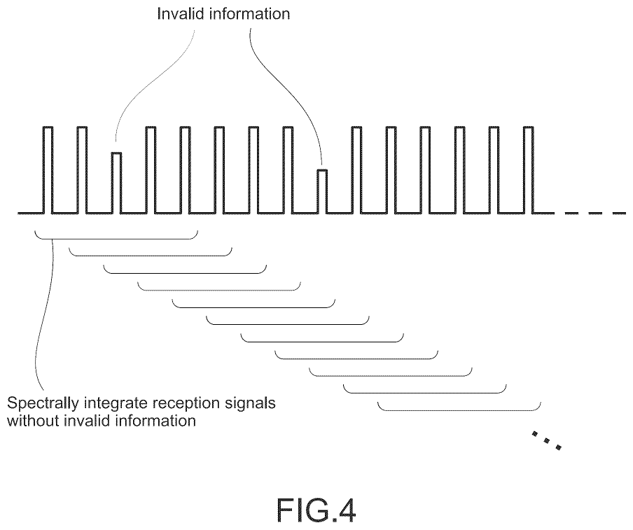

Although the wind speed data may be used as it is, use of an average value over a certain period of time can provide more reliable data without minute variations. At that time, if the wind speed data to be averaged contains invalid information, the error in the average value becomes large. Therefore, it is favorable to calculate an average value by removing the data to which invalidity flags are added, as shown in FIG. 4.

In this embodiment, the control arithmetic unit 20 removes reception signals to which the invalidity flags are added and then spectrally integrates the other reception signals to calculate wind speed data from a moving average value of the integrated values. The time range to be spectrally integrated is moved with time, so that measured values with higher data rate can be used as inputs for automatic control.

The method of calculating an average value may be averaging of wind speed values, but in this case, no improvement in the signal-to-noise ratio (SNR) can be expected. Therefore, the spectral data of the wind speed is integrated to improve the SNR at the same time. The improvement in SNR is expected to provide an advantageous effect of improving reliability and measurement accuracy. However, if the average value is used as an input for automatic control every time an average value over a certain period of time is obtained, the data rate becomes low and the discontinuity of control becomes large. Therefore, a moving average value is calculated by parallel computing to prevent data rate degradation. Delays caused by averaging are compensated by setting the information range to be used at a distant location.

If the invalidity flags are added to some range bins as reliability information or if the invalidity flags are not added to all range bins, the control arithmetic unit 20 calculates a numerical value obtained by dividing the estimated measurement error serving as reliability information by a second set value to be subtracted from 1, as an authority for each range bin (Step 104).

For the second set value described above, a variable is used, which is obtained by, for example, multiplying a measured value of the up-down wind speed (wind speed data on the optical axis L1, L2) by a coefficient of 1 or less (e.g., 0.5 to 1). The measured value of the up-down wind speed is expressed as a relative value with respect to the up-down wind actually encountered by the aircraft 200. If the reliability of the entire system is high, setting a numerical value close to 1 for the coefficient increases effectiveness of the control. On the other hand, if the reliability of the entire system is low, setting a small numerical value can reduce the risk of vibrations caused by the control.

Subsequently, the control arithmetic unit 20 calculates a control surface angle to reduce the action of the wind speed exerted on the aircraft (Step 105). In the calculation of a control surface angle, a control surface angle to reduce the vertical acceleration of the aircraft due to changes in wind speed is calculated. At that time, a control surface angle command is transmitted to an actuator of the control surface 30 after multiplying the calculated amount of change in control surface angle by the larger value of either 0 or the authority and then transmitting the control surface angle command (Step 106).

In this case, if the invalidity flags are added to some range bins as reliability information or if the invalidity flags are not added to all range bins, the control arithmetic unit 20 calculates a value obtained by subtracting the estimated measurement error from the measured value of the wind speed for each range bin, assumes the larger value of either that value or 0 as a correct measured value of the wind speed, and uses it as a control input.

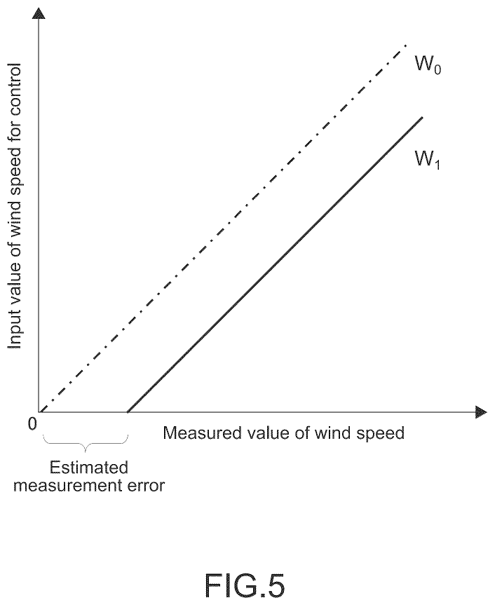

This will be described with reference to FIG. 5. When the measured value of the wind speed is used as it is as a control input, for example, a function W₀ indicated by the dashed-dotted line is used as a control input. In contrast, in one embodiment of the present invention, a function W₁, which is obtained by subtracting the estimated measurement error from the wind speed data, is used as a control input as indicated by the solid line. This results in a reduction of the risk that the measured value of the wind speed increases due to errors, and excessive control causes vibrations even though the actual wind speed is small.

If a measurement error of a certain range bin is larger than an absolute value assumed in advance or if the invalidity flags are added to only some range bins as reliability information, the control arithmetic unit 20 may use a value interpolated with the two nearest values, instead of using the value of the range bin, as a control input.

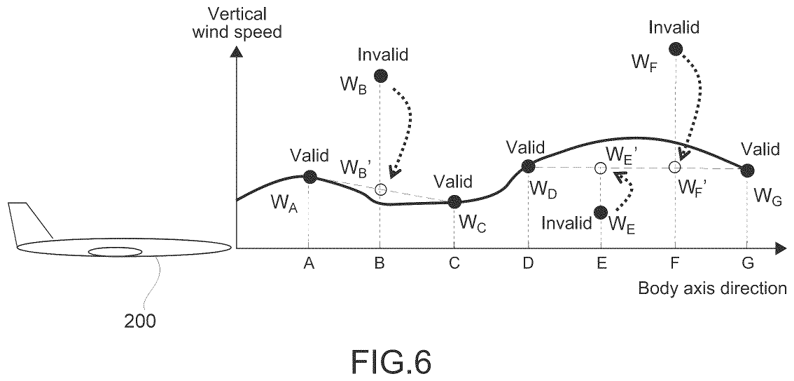

This will be described with reference to FIG. 6. The invalidity flag is added to a range B, and thus W_{B} is not used as the wind speed value of this range bin, but a value W_{B}′ obtained by interpolating wind speed values W_{A} and W_{C} in the range bins A and B on both sides is used. If range bins to which the invalidity flags are added are continuous, like ranges E and F, values W_{E}′ and W_{F}′ obtained by interpolating wind speed values W_{D} and W_{G} in the nearest ranges D and G are used. A control input is obtained using those wind speed values and, for example, the technology described in Patent Literature 1, Non-Patent Literature 3, or Non-Patent Literature 4. This results in a reduction of the risk that the measured value of the wind speed increases due to errors and excessive control causes vibrations even though the actual wind speed is small.

If a bias-like measurement error that is a constant value is added to the measured value of each range bin, the control arithmetic unit 20 may calculate a control input that is robust against the measurement error by using a control gain that cancels out the influence of the error. In this case, a control input is first calculated on the basis of the following equation.

$$u ( k ) = {K}_{BX} ( k ) + {k}_{0} {w}_{a} ( k ) + {k}_{1} {w}_{a} ( k + 1 ) + … + {k}_{n} {w}_{a} ( k + n ) \qquad [ Math . 1 ]$$

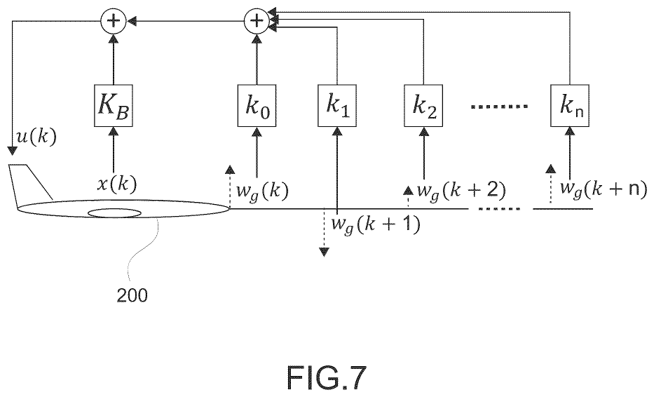

A control law is given as a discrete-time system. u(k) represents a current value of a control input (elevator command). x(k) is a vector representing a state quantity of the aircraft 200 (specifically, speed, angular velocity, attitude angle, or the like). wₐ(k) represents a vertical wind speed actually encountered by the aircraft 200. wₐ(k+1) represents a vertical wind speed to be encountered by the aircraft 200 one discrete-time step after the current time. wₐ(k+n) represents a vertical wind speed to be encountered by the aircraft 200 n discrete-time steps after the current time. Those wind speeds are substituted with lidar measured values. For example, if a sampling period is assumed as T seconds and the speed of the aircraft 200 is assumed as V, a measured value V×T×n(m) ahead from the position of the aircraft 200 is used as wₐ(k+n). If this position and the range bin do not match, a value obtained by interpolating the measured value in a nearby range bin is used as a substitute. K_{B} is a constant gain matrix multiplied by a state quantity, which may be designed using any method. Additionally, k₀, k₁, . . . , kₙ are gains multiplied by the wind speed, which can be obtained using the technology of Non-Patent Literature 4. The structure of such a control input is shown in FIG. 7.

A control gain that cancels out the bias error can be obtained by solving with the following constraints on k₀, k₁, . . . , kₙ in the design method of Non-Patent Literature 4.

$${k}_{n} = - {k}_{0} - {k}_{{1}^{-}} … - {k}_{n - 1}$$

Since the design method of Non-Patent Literature 4 solves an optimization problem with linear constraints regarding these gains, this design method can be also applied to the case where the above constraints are provided. When a bias error δ is added to each vertical wind speed value and when a control input is calculated using the gains obtained under those constraints, k₀+k₁+ . . . kₙ=0, and thus the following equation is obtained.

$$\begin{matrix}u ( k ) = {K}_{BX} ( k ) + {k}_{0} ( {w}_{a} ( k ) + δ ) + {k}_{1} ( {w}_{a} ( k + 1 ) + δ ) + … + {k}_{n} ( {w}_{a} ( k + n ) + δ ) \\ = {K}_{BX} ( k ) + {k}_{0} {w}_{a} ( k ) + {k}_{1} {w}_{a} ( k + 1 ) + … + {k}_{n} {w}_{a} ( k + n ) + δ ( {k}_{0} + {k}_{1} + … + {k}_{n} ) \\ = {K}_{BX} ( k ) + {k}_{0} {w}_{a} ( k ) + {k}_{1} {w}_{a} ( k + 1 ) + … + {k}_{n} {w}_{a} ( k + n )\end{matrix} \qquad [ Math . 2 ]$$

where the influence of the bias error δ is canceled out. This results in a reduction of the risk that the measured value of the wind speed increases due to the bias error and excessive control causes vibrations even though the actual wind speed is small.

Here, for the purpose of reducing a vertical acceleration of the aircraft 200, for example, flaperons that change the left and right ailerons in the same phase are assumed as a control surface 30 to be controlled, but the present invention is not limited thereto. Spoilers or DLC flaps may be used, or several of them may be used in combination. Alternatively, the elevators may be used to change the attitude to indirectly change the lift.

Additionally, for the purpose of reducing the change in the airspeed of the aircraft 200 due to wind shear, a throttle or a spoiler is assumed as a control surface to be controlled, but the present invention is not limited thereto. Either or both of the throttle and the spoiler may be used. Alternatively, in the case of a propeller aircraft, a pitch angle can also be used.

In general, in a jet aircraft, it is reasonable to use throttle to adjust an airspeed, but a large time constant causes a delay of 10 or more seconds. The deployment of spoilers increases drag and thus decreases fuel efficiency. Therefore, in deceleration, it is appropriate to control the throttle and spoilers to be deployed simultaneously and the spoilers to be gradually retracted as the airspeed decreases. In acceleration, only the throttle is used. In this regard, it is difficult to assume a situation in which increased speed control is necessary during cruising, and it is assumed that stall prevention is necessary during takeoff and landing. However, since the observation distance of the Doppler lidar is long at low altitudes, it is considered that effectiveness is exhibited by the throttle control alone. In this case, the optical axis does not need to be two lines of sight. For example, the measurement range can be set to 8 km by setting one line of sight to face in the flight direction, setting the number of range bins to 80, and setting the distance width of the range bin to 100 m.

Further, for the purpose of reducing a lateral acceleration of the aircraft 200, a rudder is assumed as a control surface to be controlled. Ailerons may be used in combination to apply a steady lateral G. In this case, unlike the above examples, it is necessary to emit laser light forward and to the right and left to measure crosswind.

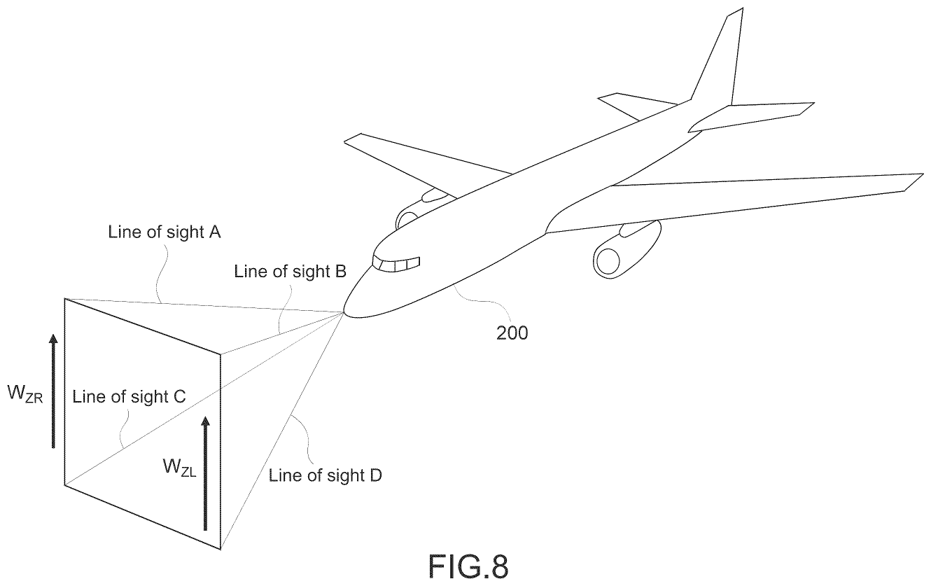

For the purpose of reducing variations in the roll angle of the aircraft 200, ailerons are assumed as a control surface to be controlled. In this case, for example, four lines of sight A to D are measured as shown in FIG. 8. It only needs to convert measured values of the line of sight A and the line of sight C into vectors and calculate a vertical wind W_{ZR} encountered by the right wing, to convert measured values of the line of sight B and the line of sight D into vectors and calculate a vertical wind W_{ZL} encountered by the left wing, and to control the ailerons such that the variations in the roll angle are reduced on the basis of the difference between W_{ZR} and W_{ZL}. Measurement of the four lines of sight makes it possible to reduce a vertical acceleration, reduce the change in airspeed due to wind shear, and reduce a lateral acceleration.

By repetition of the above processing, the automatic control of the control surface angle based on preview information (hereinafter, also referred to as preview control based on a remote airflow) is performed.

Here, in the case of conventional feedback control to reduce the acceleration of the aircraft (feedback control of the control surface 30 based on the output of the acceleration sensor 500), it may fail to respond to the initial acceleration due to a delay in control or, conversely, it may cause vibrations.

In contrast, in the case of the preview control based on a remote airflow as in the this embodiment, the control surface can be controlled in anticipation of delays. Thus, no influence of average delays occurs, and only slight influence such as observation errors and control surface angle errors in a remote airflow remains.

As described above, according to this embodiment, appropriate use of the information for determining an estimation error or validity/invalidity of the measurement in control makes it possible to improve the control accuracy and reliability. Additionally, according to this embodiment, even if there is a slight measurement error in the preview information, it is possible to reduce the acceleration of the aircraft or the load applied to the aircraft when the aircraft enters turbulence.

Numerous accidents have occurred due to turbulence, one which is, for example, the accident of American Airlines Flight 280 that occurred on Dec. 16, 2014. The aircraft unexpectedly encountered clear-air turbulence that could not be detected by radar, which caused a big vertical acceleration of the aircraft and resulted in serious injuries to the passengers and crews. Such an accident could be prevented by applying the present invention to suitably and automatically control the lift and to reduce the vertical acceleration of the aircraft when the aircraft encounters turbulence.

Additionally, in the case of the accident of Japan Airlines Flight 356 that occurred on Oct. 21, 2002, the aircraft was shaken due to inappropriate maneuvering in response to an increase in airspeed caused by wind shear, and the passengers and crews were seriously injured. Such an accident could be prevented by applying the present invention to suitably and automatically control the thrust and to cancel out the increase in airspeed caused by wind shear.

Further, in the case of the accident of All Nippon Airways Flight 569 that occurred on Sep. 27, 2002, the aircraft was shaken sideways due to abrupt changes in crosswind, and the passengers were seriously injured. Such an accident could be prevented by applying the present invention to suitably and automatically control the rudder and to reduce the lateral acceleration of the aircraft caused by the changes in crosswind just prior to landing.

### [Application Example of Gust Alleviation System]

An application example of the present invention as a gust alleviation system will be shown below. Similar to Non-Patent Literature 3, a minute longitudinal motion, which is obtained by linear approximation from a horizontal steady flight state, of a large airliner equipped with four jet engines will be discussed. Conditions such as altitude and speed in the horizontal steady flight state are shown in Table 1 below.

TABLE 1

| | | |
|---|---|---|
| Altitude | 9144 | [m] |
| Airspeed | 218.3 | [m/s] |
| Angle of attack | 3.260 | [deg] |
| Elevator control surface angle | 1.264 | [deg] |

For the mathematical model representing the motion, a control law is designed to generate control inputs for gust alleviation by using the technology of Non-Patent Literature 4. Elevators are used as a control surface to be controlled. At that time, the control law is expressed by the following equation.

$$u ( k ) = {K}_{Bx} ( k ) + {k}_{0} {w}_{a} ( k ) + {k}_{1} {w}_{a} ( k + 1 ) + … + {k}_{n} {w}_{a} ( k + n ) \qquad [ Math . 3 ]$$

The control law is given as a discrete-time system. u(k) represents a current value of a control input (elevator command). x(k) is a vector representing a state quantity of the aircraft (specifically, speed, angular velocity, attitude angle, or the like). wₐ(k) represents a vertical wind speed actually encountered by the aircraft. wₐ(k+1) represents a vertical wind speed to be encountered by the aircraft one discrete-time step after the current time. wₐ(k+n) represents a vertical wind speed to be encountered by the aircraft n discrete-time steps after the current time. Those wind speeds are substituted with lidar measured values. For example, if a sampling period is assumed as T seconds and the speed of the aircraft is assumed as V, a measured value V×T×n(m) ahead from the position of the aircraft is used as wₐ(k+n). If this position and the range bin do not match, a value obtained by interpolating the measured values in the nearby range bins is used as a substitute. K_{B} is a constant gain matrix multiplied by a state quantity, which may be designed using any method. Additionally, k₀, k₁, . . . , kₙ are gains multiplied by the wind speed, which can be obtained using the technology of Non-Patent Literature 4.

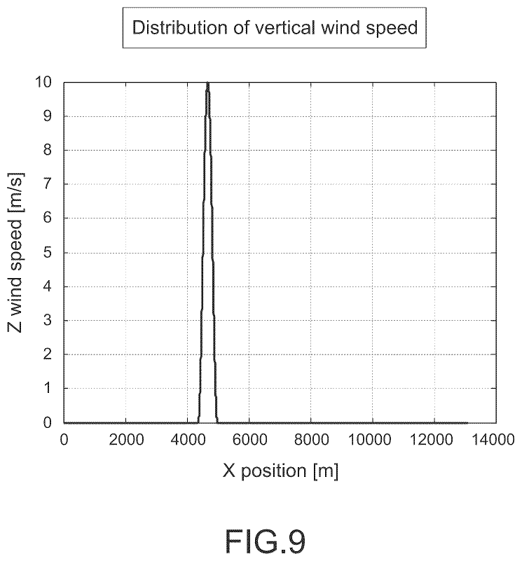

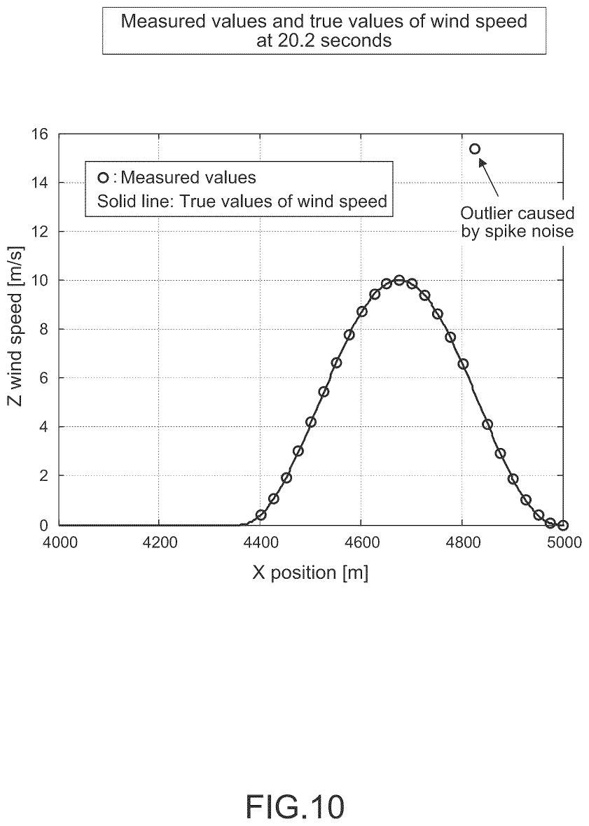

A simulation was performed in which the aircraft is subjected to a vertical gust. The aircraft advances along the X axis from X=0 and its speed is approximately 220 m/s. Measured values of the vertical wind speed up to 600 m ahead on the X axis are obtained from the measurement unit every 0.1 second, with the distance width of a range bin being as 25 m. The vertical wind speed encountered by the aircraft is assumed to have a uniform flow with the distribution shown in FIG. 9 (a wind speed flow with the same distribution regardless of altitude). It is a vertical flow with a peak value of 10 m/s at the position of 4676 m on the X axis. Spike noise is assumed to occur with a probability of 1% for the measurement of each range bin. FIG. 10 shows an example of measured values and true values.

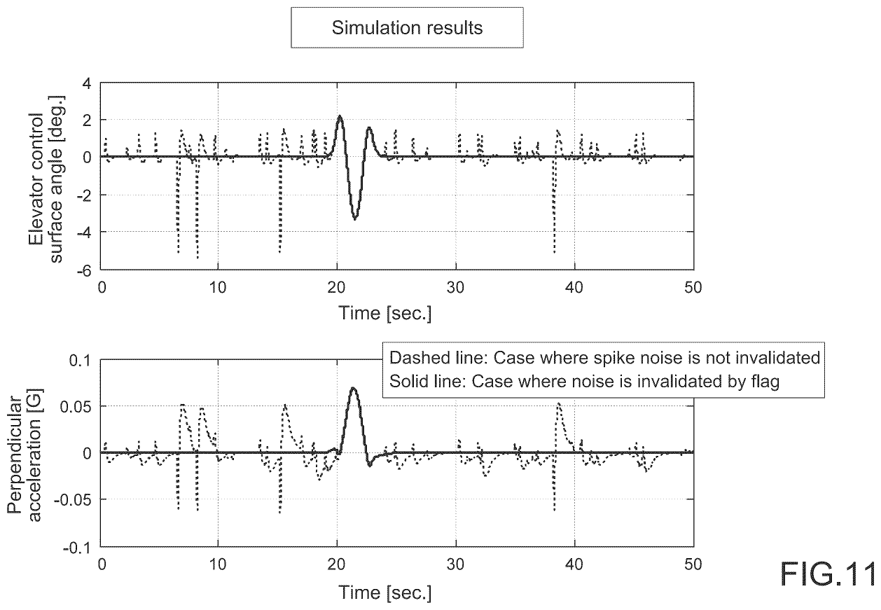

The circles in FIG. 10 represent the measured values of the respective range bins at 20.2 seconds after the start of the simulation, in which a large spike noise appears on the measured value near the position of 4800 m, resulting in an outlier. The simulation results obtained by the control using those measured values are shown in FIG. 11. The dashed lines show an elevator control surface angle and a perpendicular acceleration when directly affected by spike noise, and the solid lines show an elevator control surface angle and a perpendicular acceleration when a spike noise invalidation procedure is performed using the invalidity flags. In the case of the dashed lines, excessive elevator control surface angle commands are generated due to the influence of the spike noise, resulting in the occurrence of large perpendicular accelerations. In contrast, in the case of the solid lines, the spike noise is invalidated by the present invention, and the behavior as indicated by the dashed lines does not occur.

Note that this simulation shows an advantageous effect of the present invention as the gust alleviation system, but the present invention is also applicable to a gust load alleviation system. This simulation calculates K_{B} and K_{F} that minimize the perpendicular acceleration using the technology of Non-Patent Literature 4, but the same technology can also calculate a gain that minimizes the load. The present invention can also be applied to a gust load alleviation system configured using such a gain.

Note that it is favorable to simply provide the pilot with preliminary information on turbulence rather than to perform the vertical control according to the present invention, for example, at flight altitudes of 500 m or less, because the concentration of aerosol particles in the atmosphere is high at low altitudes during takeoff and landing and the observation distance of the Doppler lidar is long; crews and passengers are wearing seatbelts; the flight path can be changed at the discretion of the pilot alone; and there is a risk of a crash due to loss of altitude if the control according to this invention fails.

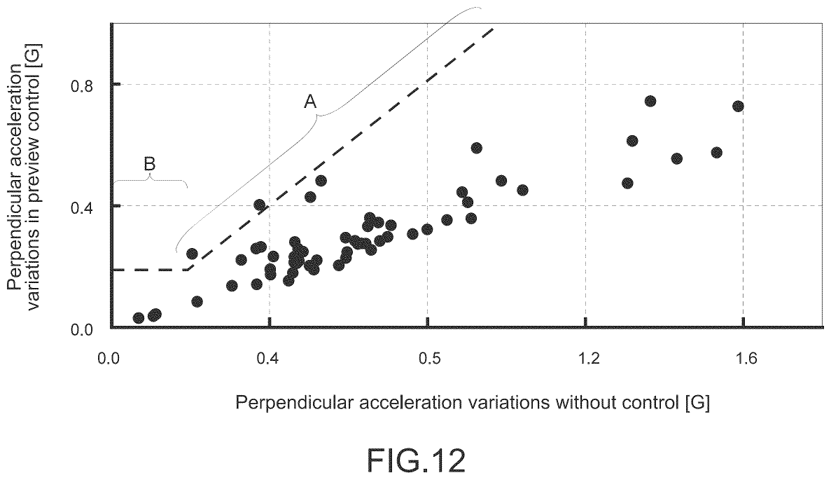

Regardless of the application of the present invention, the effectiveness of the automatic control system has to be evaluated for its application. FIG. 12 shows a flight simulation example, in which the horizontal axis represents perpendicular acceleration variations without control, and the vertical axis represents perpendicular acceleration variations when the present invention is applied. According to the automatic control system of this embodiment, a certain reduction effect was confirmed for the acceleration of the aircraft due to a wind speed, as indicated by the resulting plots displayed below the dashed line in the part A. In this example, most of the plots are below the dashed line, showing that the acceleration has been reduced by almost half by the control, but some plots are above the dashed line. To achieve a practical application, it only needs to determine whether or not the probability and the amount of divergence of those plots are allowable. The dashed line in the part B includes a portion where the acceleration increases by the control, but it only needs to set the amount of acceleration variations that has little adverse effect even if the acceleration increases.

The above example shows the flight simulation results based on the data of wind actually encountered by the aircraft, but the flight test results may also be displayed. Additionally, this description relates to the change in acceleration, but the effectiveness of the control for the change in load can also be evaluated by the same method.

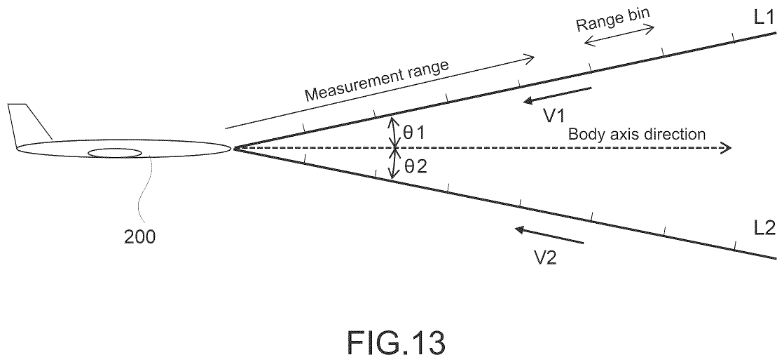

For the reliability information of the wind speed measurement that is output from the measurement unit 10 of the automatic control system 1 of the aircraft, for example, a calculation method using hardware processing as in the technology of Patent Literature 4 is excellent, but it has a disadvantage of increasing cost and size. For this reason, a simplified calculation method using software will be described with reference to FIG. 13.

In FIG. 13, when the angles formed by the optical axes L1 and L2 with respect to the aircraft body axis direction are θ1 and θ2, respectively, θ1 and θ2 are assumed to be 5 to 10 degrees. In this case, the observations are considered to be performed in almost the same direction. Therefore, a difference between a wind speed V1 a wind speed V2 of the range bins at the same distance is regarded as a measurement error. However, since the presence of turbulence may be superimposed on the measurement error, the measurement error may be multiplied by a coefficient less than 1. When an airflow vector is estimated from each measured value obtained from each observation axis, the airflow vector is estimated assuming that the measurement value includes a measurement error, and an estimation error thereof is calculated at the same time. At that time, if the measurement error or the estimation error is extremely large as compared to normal turbulence that can occur in the natural world, for example, if the wind speed difference between the observation axes exceeds 10 m/s, the reliability of airflow vector estimation is reduced, and the measured values are determined as being invalid and an invalidity flag is applied to the output data string. A threshold for this determination may differ depending on the ranges.

### [Others]

More than half of accidents of passenger airplanes are related to turbulence, and reducing turbulence accidents is an urgent issue. For this reason, in the case of passenger airplanes, weather radar equipment is mandatory, which can find cumulonimbus clouds that generate turbulence but fails to detect turbulence that occurs in clear weather conditions.

In contrast, the Doppler lidar has a feature capable of performing a remote airflow observation in clear weather, but it has a short effective observation range, which is pointed out by pilots of airline companies and is a heavy drag on practical use of the Doppler lidar. However, even with a short effective observation range of approximately 500 m, the gust alleviation system of the present invention can be suitably applied as means for reducing the acceleration of the aircraft when an aircraft encounters turbulence.

The present invention is not limited to the embodiment described above and can be variously modified and implemented. The range of the implementation belongs to the range of the technical ideas of the present invention.

For example, the above embodiment has been described on the assumption that a Doppler lidar using light waves as a kind of electromagnetic waves is used as the measurement unit 10, but it may also be applied to a Doppler radar using radio waves. In this case, the measurement unit emits radio waves toward a planned flight direction of the aircraft, receives scattered waves in the atmosphere, and measures a remote wind speed in an emission axis direction of radio waves on the basis of the Doppler shift amount of the scattered waves with respect to the emitted radio waves.

In the embodiment described above, the case where the optical axis of the laser light is directed in two forward and up-down directions, has been described, but the present invention can also be applied even when the laser light is directed in two forward and right-left directions or in three or more directions (in the example in FIG. 8, four directions).

Further, the embodiment described above has been described assuming that it is applied to an aircraft as the aircraft 200, but it can also be applied, for example, to the case of reducing the acceleration of a vessel by observing ocean waves or water currents in the advance direction of the vessel. Even for vehicles, an effect of preventing accidents caused by gusts, for example, at tunnel exits, can be expected.
1 gust or gust load alleviation system
10 measurement unit
11 signal processing unit
12 optical transceiver
13 switcher
14 second telescope
15 first telescope
20 control arithmetic unit
30 control surface
40 window
200 aircraft

1. An automatic control system of an aircraft, comprising:
a measurement unit that measures, as preview information, a difference between a wind speed actually received by an aircraft and a wind speed to be encountered in future, adds information for identifying an estimation error or validity/invalidity of a measured value to measurement information, and outputs the resultant information;
a control surface that controls lift, drag, or an attitude of the aircraft, or an apparatus that controls thrust; and
a control arithmetic unit that calculates an angle of the control surface or the thrust to reduce an action of the wind speed exerted on an aircraft, on a basis of a wind speed value in a planned flight direction of the aircraft, the wind speed value being measured by the measurement unit, and generates a control command to be output to the control surface or the apparatus on a basis of a calculated value.

2. The automatic control system of an aircraft according to claim 1, wherein
the measurement unit emits electromagnetic waves toward the planned flight direction of the aircraft, receives scattered waves in atmosphere, and measures a remote wind speed in an emission axis direction of the electromagnetic waves on a basis of a Doppler shift amount of the scattered electromagnetic waves with respect to the emitted electromagnetic waves.

3. The automatic control system of an aircraft according to claim 2, wherein
the measurement unit provides two or more lines of sight of emission axes of the electromagnetic waves or performs scanning by the electromagnetic waves to obtain a two-dimensional or three-dimensional vector of the wind speed.

4. The automatic control system of an aircraft according to claim 1, wherein
the control arithmetic unit calculates the wind speed value on a basis of a moving average value of spectrally-integrated reception signals from which a reception signal with invalidity information has been removed.

5. The automatic control system of an aircraft according to claim 1, further comprising
an acceleration sensor that detects an acceleration acting on the aircraft, wherein
the control arithmetic unit performs automatic control of the control surface on a basis of an output of the acceleration sensor if the estimation error has a set value or more or if preview information with invalid information is received.

6. The automatic control system of an aircraft according to claim 1, wherein
the control arithmetic unit defines a numerical value obtained by dividing the estimation error by a set value to be subtracted from 1, as an authority, and multiplies the control command by a larger value of 0 or the authority.

7. The automatic control system of an aircraft according to claim 1, wherein
the control arithmetic unit generates a control signal by regarding a larger value of a value obtained by subtracting the estimation error from the measured value or 0 as the wind speed value.

8. The automatic control system of an aircraft according to claim 1, wherein
if a measurement error of a certain range bin is larger than an absolute value assumed in advance or if invalid information is added to the measured value, the control arithmetic unit calculates the angle of the control surface by using measured values of range bins located before and after the certain range bin.

9. The automatic control system of an aircraft according to claim 1, wherein
if a bias-like measurement error that is a constant value is added to the measured value of each range bin, the control arithmetic unit uses a control gain that cancels out an influence of the bias-like measurement error.

10. An effectiveness evaluation method for the automatic control system of an aircraft according to claim 1, comprising:
performing a flight test or flight simulation of an aircraft under a predetermined wind speed flow condition including a vertical wind speed;
plotting results of the flight test or flight simulation, with a horizontal axis representing an acceleration change amount of the aircraft when automatic control based on the control command is not performed and a vertical axis representing an acceleration change amount of the aircraft when the automatic control is performed; and
regarding divergence of plots below a line graph set in advance as a gust alleviation effect provided by the automatic control.

11. A measurement apparatus for an automatic control system of an aircraft that measures, as preview information, a difference between a wind speed actually received by an aircraft and a wind speed to be encountered in future, the measurement apparatus comprising
a signal processing unit that adds, as information for determining validity/invalidity, a difference between measured values obtained from two or more lines of sight of emission axes of electromagnetic waves to measurement information and outputs the resultant information.
